(19) United States
(12) Patent Application Publication
(10) Pub. No.: US 2015/0026126 A1
(43) Pub. Date: Jan. 22, 2015

(54) METHOD OF REPLICATING DATA IN ASYMMETRIC FILE SYSTEM

(71) Applicant: ELECTRONICS AND TELECOMMUNICATIONS RESEARCH INSTITUTE, Daejeon (KR)

(72) Inventors: Sang-Min LEE, Daejeon (KR); Hong Yeon KIM, Daejeon (KR); Young Kyun KIM, Daejeon (KR)

(73) Assignee: ELECTRONICS AND TELECOMMUNICATIONS RESEARCH INSTITUTE, Daejeon (KR)

(21) Appl. No.: 14/071,796

(22) Filed: Nov. 5, 2013

(30) Foreign Application Priority Data
Jul. 18, 2013 (KR) 10-2013-0084967

(51) Int. Cl. G06F 17/30

(52) U.S. Cl. CPC G06F 17/30575
USPC 707/634

(57) ABSTRACT

A method of efficiently replicating data stored in data servers in an asymmetric file system is provided. A replication processing apparatus of a network transmits a replication request only to a data server that does not replicate data so that it is possible to reduce replication time of a data block and to extend time-out with reference to a response message transmitted by the data server. In addition, each of the data servers may efficiently transmit copy data to another data server by a pipeline data transmission method.

### CROSS-REFERENCE TO RELATED APPLICATION

This application claims priority to and the benefit of Korean Patent Application No. 10-2013-0084967 filed in the Korean Intellectual Property Office on Jul. 18, 2013, the entire contents of which are incorporated herein by reference.

### BACKGROUND OF THE INVENTION

(a) Field of the Invention

The present invention relates to a method of replicating data in parallel in an asymmetric large capacity file system.

(b) Description of the Related Art

In general, a data server stores and manages data using a hard disk or a solid state drive (SSD) as a storage medium. Data processing performance of the data server is dependent on performance of the storage medium. In this case, when a number of data requests are simultaneously processed, the data processing performance may be deteriorated.

On the other hand, in order to secure expandability, each of most large capacity storage systems adopts an asymmetric structure in which metadata and data are processed by a management server and data servers, respectively. That is, in the large capacity storage system, the data servers store and manage data of a user and the metadata management server stores and manages the metadata.

A data server that stores data reads a data block of a storage medium and transmits the data to another data server through a network, and the data server that receives the data records the received data in the data block of the storage medium so that the data may be replicated. At this time, most time is spent on the storage medium reading the data and writing the data in the storage medium.

In the large capacity storage system, due to re-replication of data, a large reading/writing load may be generated in the data server. In addition, since maximum data block reading/writing performance is determined in one data server, when the data is replicated a number of times, replication performance is difficult to improve. In addition, when a large amount of data is replicated, performance of a storage service may be deteriorated.

In general, a large capacity storage system may consist of a plurality of data servers including a plurality of storage media. At this time, since data processing performances of the respective data servers are limited, although the respective data servers receive large amounts of data replication requests, it may take a long time.

On the other hand, the storage system replicates data to store the replicated data in another data server in case the data server is out of order. Therefore, although the data server is out of order, the replicated data is provided from another data server included in the system so that availability of the storage system may be guaranteed.

At this time, due to data replication for guaranteeing availability, loads may be generated in a number of data servers and a data bottleneck phenomenon may be generated when the storage service is provided to a user.

### SUMMARY OF THE INVENTION

According to an exemplary embodiment of the present invention, a method of smoothly providing a storage service by controlling a speed at which a data replication request is processed is provided.

According to an exemplary embodiment of the present invention, a method of replicating a data block stored in a plurality of data servers in a replication processing apparatus is provided. The method of replicating the data block includes determining whether at least two data servers among the plurality of data servers may replicate the data block, when it is determined that the at least two data servers may replicate the data block, selecting a first data server in which the data block is stored and a second data server in which the data block is not stored from the at least two data servers, transmitting a replication request of the data block to the first data server, and receiving a response message from the first data server.

In the method of replicating the data block, the determining of whether at least two data servers among the plurality of data servers may replicate the data block may include comparing the number of replication requests that are on standby in a replication request queue of the replication processing apparatus with a number of replication available semaphores, and determining that the data block may be replicated when the number of replication requests is smaller than the number of replication available semaphores.

In the method of replicating the data block, the number of replication available semaphores is calculated using an intradata re-replication parallelism value and an inter data re-replication parallelism value.

In the method of replicating the data block, the intradata re-replication parallelism value is obtained by dividing the number of online data servers by 2.

The method of replicating the data block may further include searching file metadata including position information of the data block to determine whether the data block is to be replicated.

In the method of replicating the data block, in searching file metadata including position information of the data block to determine whether the data block is to be replicated, the data block may be determined to be replicated when the number of data blocks included in the file metadata is smaller than the target number of copies set by the replication processing apparatus.

In the method of replicating the data block, selecting a first data server in which the data block is stored and a second data server in which the data block is not stored from the at least two data servers may include determining whether the first data server and the second data server may replicate the data block through server resource semaphores of the first data server and the second data server, and selecting the first data server and the second data server when the server resource semaphores exist in the first data server and the second data server.

In the method of replicating the data block, transmitting a replication request of the data block to the first data server may include transmitting a request identifier of the replication request and an identifier of the data block to the first data server.

In the method of replicating the data block, receiving a response message from the first data server may include receiving a response message informing that a replication request is successfully fulfilled when the data block stored in the first data server is successfully replicated in the second data server.

The method of replicating the data block may further include starting time-out for the replication request after transmitting the replication request, and receiving the response message may include determining whether the time-out is to be terminated based on the response message.

In the method of replicating the data block, determining whether the time-out is to be terminated may include starting the time-out again when an in progress message is included in the response message and the response message is received before the time-out for the replication request is terminated.

In the method of replicating the data block, determining whether the time-out is to be terminated may include recognizing an identifier of the replication request included in the response message to delete the replication request from the replication request queue when an in progress message is not included in the response message or the response message is received after the time-out for the replication request is terminated.

According to another exemplary embodiment of the present invention, a method of a data server that stores a data block to replicate the data block is provided. The method of replicating the data block includes receiving a first replication request of the data block from a replication processing apparatus through a network, reading out a first part of the data block by a predetermined buffer magnitude, transmitting a read out part of the first part to the first data server in which the data block is not stored, transmitting an in progress message for the replication request to the replication processing apparatus, and receiving a second replication request of the data block from the replication processing apparatus as a response to the in progress message.

The method of replicating the data block may further include, after transmitting a read out part of the first part, reading out a second part of the data block by a predetermined buffer magnitude, transmitting a read out part of the second part to the first data server, and transmitting the in progress message to the replication processing apparatus.

The method of replicating the data block may further include, after transmitting the in progress message, sleeping for predetermined sleep time, reading out a remaining part of the first part by the buffer magnitude after the sleep time passes, and transmitting a read out part of the remaining part to the first data server.

The method of replicating the data block may further include, after transmitting the in progress message, sleeping for predetermined sleep time, reading out a remaining part of the second part by the buffer magnitude after the sleep time passes, and transmitting a read out part of the remaining part to the first data server.

In the method of replicating the data block, the sleep time may be determined using a replication bandwidth allocated by the replication processing apparatus, a maximum bandwidth of the data server, and the buffer magnitude.

### BRIEF DESCRIPTION OF THE DRAWINGS

FIG. 1 is a view illustrating an asymmetric storage system.

FIG. 2 is a view illustrating a data structure of a metadata server.

FIG. 3 is a view illustrating processes of a replication processing apparatus for managing replication of file data and a data server in which the file data is stored while replicating a data block.

FIG. 4 is a view schematically illustrating processes of re-replicating a data block in parallel according to an exemplary embodiment of the present invention.

FIG. 5 is a view illustrating a plurality of data blocks replicated in a data server according to an exemplary embodiment of the present invention.

FIG. 6 is a flowchart illustrating processes of allocating a copy data block according to an exemplary embodiment of the present invention.

FIG. 7 is a flowchart illustrating processes of replicating a data block in parallel according to an exemplary embodiment of the present invention.

FIG. 8 is a view illustrating processes of a data server transmitting a data block by a pipeline data transmission method according to an exemplary embodiment of the present invention.

FIG. 9 illustrates a data structure of a replication processing apparatus according to an exemplary embodiment of the present invention.

FIG. 10 is a view illustrating processes of a replication processing apparatus replicating a data block according to an exemplary embodiment of the present invention.

FIG. 11 is a flowchart illustrating processes of re-replicating a data block in parallel according to an exemplary embodiment of the present invention.

FIG. 12 is a flowchart illustrating processes of a replication processing apparatus determining a data server to perform replication according to an exemplary embodiment of the present invention.

FIG. 13 is a flowchart illustrating processes of a replication processing apparatus processing a response message received from a data server according to an exemplary embodiment of the present invention.

FIG. 14 is a flowchart illustrating processes of a replication processing apparatus updating a replication processing list according to an exemplary embodiment of the present invention.

FIG. 15 is a flowchart illustrating processes of an original data server processing a replication request according to an exemplary embodiment of the present invention.

FIG. 16 is a view illustrating processes of controlling a replication bandwidth according to an exemplary embodiment of the present invention.

FIG. 17 is a flowchart illustrating processes of a replication processing apparatus applying time-out according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification

In the entire specification, unless explicitly described to the contrary, the word “comprise” and variations such as “comprises” or “comprising” will be understood to imply the inclusion of stated elements but not the exclusion of any other elements. In addition, the terms “ . . . unit”, “ . . . er”, “module”, and “block” described in the specification mean units for processing at least one function or operation, which may be realized by hardware, software, or a combination of hardware and software.

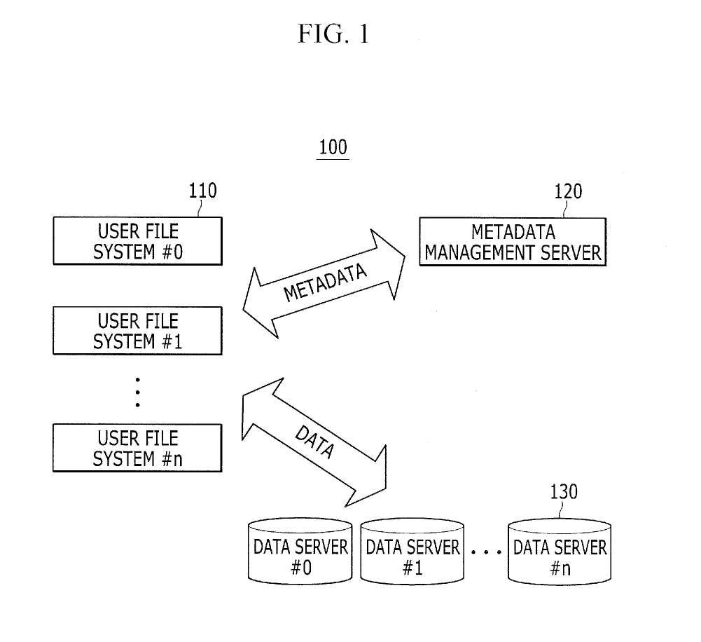

FIG. 1 is a view illustrating an asymmetric storage system.

Referring to FIG. 1, an asymmetric storage system 100 includes a plurality of user file systems 110, a metadata management server 120, and a plurality of data servers 130.

A user file system 110 receives a request related to a file from a user to inquire about metadata of the file (referred to as “file metadata” hereinafter) by the metadata management server 120 and to access a data server 130 that stores actual data of the file (referred to as “file data” hereinafter) using the inquired file metadata.

The metadata management server 120 manages the file metadata to manage position information of the file data. At this time, the metadata management server 120 may check the validity of the request of the user file system and may transmit the inquired file metadata to the user file system through a network.

The data server 130 manages the file data and transmits the file data stored in a disk in response to the request of the user file system 110. The file data may be stored in the data server 130 in units of data blocks.

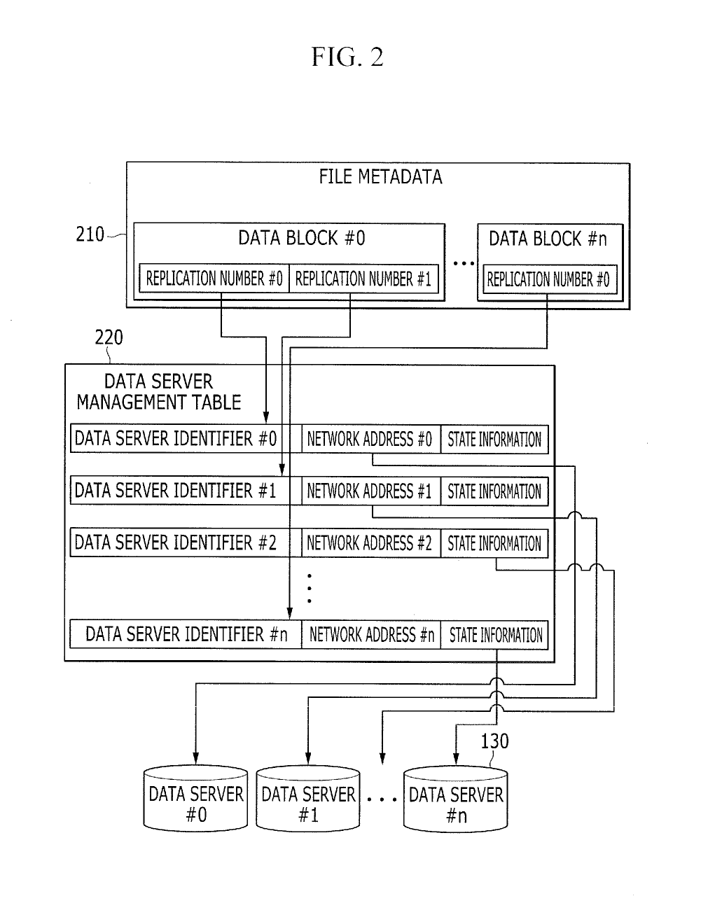

FIG. 2 is a view illustrating a data structure of a metadata server.

Referring to FIG. 2, a metadata server manages file metadata 210 and a data server management table 220.

The file metadata includes a plurality of data blocks. Each of the data blocks includes a data server identifier and a data block identifier for a part of file data. Each of the data blocks may include at least one copy.

The data server management table maintains an address and a state (e.g., ONLINE, FAILED, etc.) of a data server in which the file data is stored.

In order to read or write a file, a user may access a metadata server to bring file metadata, may find a data server identifier of a data server in which file data is stored from the file metadata, and may access the data server in accordance with an address and a state of the data server maintained in a data server management table to download the file data.

Referring to FIG. 2, the file metadata manages position information items of parts of file data items corresponding to the respective data blocks, and the number of position information items of the parts of the file data items may be n when the number of replicated data blocks is n. For example, since position information of a part of file data corresponding to a data block 0 is included in copies of the data block 0 and the number of copies of the data block 0 is 2, a user may find a data server in which the part of the file data corresponding to the data block 0 is stored through one of a data server identifier and a data block identifier of a replication number 0 and a data server identifier and a data block identifier of a replication number 1.

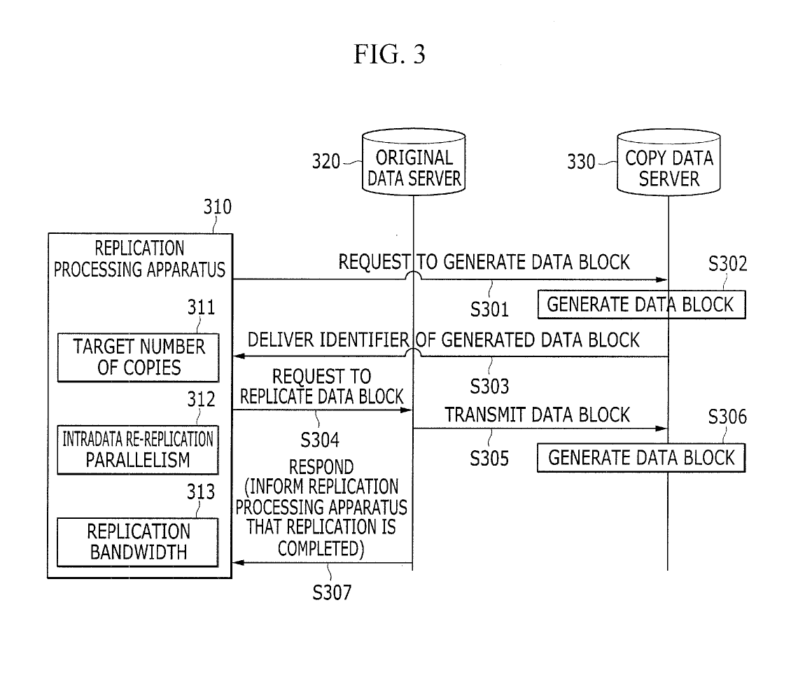

FIG. 3 is a view illustrating processes of a replication processing apparatus for managing replication of file data and a data server replicating a data block.

A replication processing apparatus 310 manages a target number of copies 311, intradata re-replication parallelism 312, and replication bandwidth 313.

The target number of copies 311 represents the number of replications of file data in an entire storage system. That is, in the asymmetric file system 100, since a predetermined number of file data corresponding to a specific file are maintained, when an error is generated in a specific data server, the target number of copies 311 may be set by the number of reduced replicated file data.

The intradata re-replication parallelism 312 represents the number of replications that may be simultaneously performed when a data block is replicated. For example, when a data server replicates a data block in a simple data transmission method, since another data block may be replicated for a response standby time, the intradata re-replication parallelism may be 2, and when a data server replicates a data block in a pipeline data transmission method, since there is no response standby time, the intradata re-replication parallelism may be 1.

The replication bandwidth 313 represents a maximum bandwidth value available among data servers when data is replicated among the data servers.

Processes of replicating a data block between the replication processing apparatus 310 and a data server are as follows.

First, when a replication request event for specific file data is detected, the replication processing apparatus 310 requests a data server (a copy data server) 330 in which replicated file data is to be stored to generate a data block (S301).

At this time, the replication processing apparatus 310 may detect a replication request event generated in the data server through a multiple event sensing mechanism such as a poll. When the replication request event is sensed, the replication processing apparatus 310 may manage a replication request received from a data server in which a replication request event is generated through a replication request queue.

The copy data server 330 requested to generate a data block generates the data block (S302) and delivers a data block identifier of the generated data block to the replication processing apparatus 310 (S303).

Then, the replication processing apparatus requests a data server (an original data server) 320 in which an original data block of specific file data is stored to replicate the data block (S304).

For example, when replicated file data is to be stored in a data server 5, the replication processing apparatus requests the data server 5 to generate a data block, and when an original data block is stored in data servers 1 to 3, the replication processing apparatus requests the data servers 1 to 3 to replicate file data.

When the replication processing apparatus 310 requests the original data server 320 to replicate file data, a request identifier of a replication request, an identifier of a data block, an address of a data server in which data is to be stored, and a data block identifier of a data block in which data is to be stored may be delivered.

Then, the original data server 320 requested to replicate data transmits a data block to the copy data server S305 to complete replication of the data block (S306), and informs the replication processing apparatus 310 that replication of the data block is completed (S307). At this time, the original data server 320 may deliver a replication request identifier and a replication result state to the replication processing apparatus.

On the other hand, processes of replicating one data block (a data block id) between two data servers (a data server a and a data server b) may be represented by Equation 1.

$${Repl}_{a \to b} = {\sum }_{i = 1}^{N} {B ( a , b )}_{id , offset , len} ( N = \frac{block size}{len} , offset = ( i - 1 ) \cdot len ) \\ {B ( a , b )}_{id , offset , len} = {Read}_{p 1 , len} + {Send}_{len} + {Recv}_{len} + {Write}_{p 2 , len} \\ ( p 1 = T ( a , id , offset ) , p 2 = T ( b , id , offset ) \qquad ( Equation 1 )$$

Referring to the Equation 1, the data server a in which a data block to be replicated is stored divides the data block to be replicated by a unit length to perform replication in units of divided data blocks. That is, the divided data blocks are read from a disk of the data server a, are transmitted to the data server b through a network, and are recorded in the data server b. Then, the data server b transmits a response (a reply) thereto. At this time, a T function may represent a physical position of a disk for an offset of the data block id stored in the data server a.

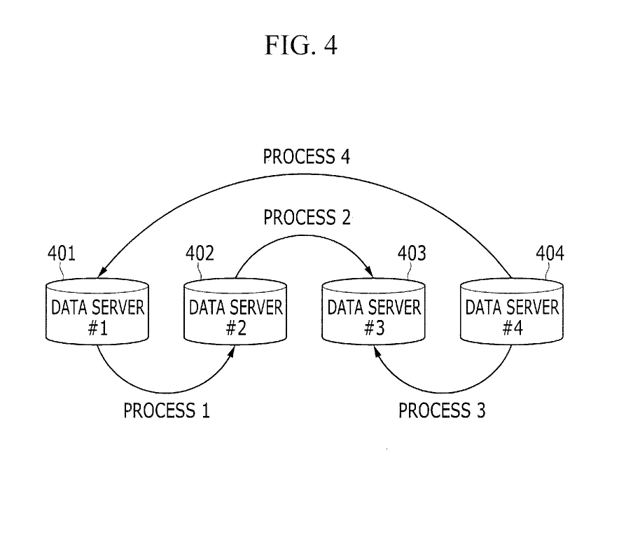

FIG. 4 is a view schematically illustrating processes of re-replicating a data block in parallel according to an exemplary embodiment of the present invention.

Referring to FIG. 4, processes of re-replicating a data block in parallel according to the exemplary embodiment of the present invention may be performed among four data servers 401 to 404. Each of the data servers may use a plurality of disks as storage media.

According to the exemplary embodiment of the present invention, the four data servers 401 to 404 perform the following four data block replicating processes.
Process 1: the data server 1→the data server 2
Process 2: the data server 2→the data server 3
Process 3: the data server 4→the data server 3
Process 4: the data server 4→the data server 1

At this time, the respective processes may be performed in parallel with two processes paired. Since there are four processes, there are three combinations of processes that may be performed in parallel.
Pair 1: {(the process 1 and the process 2), (the process 3 and the process 4)}
Pair 2: {(the process 1 and the process 3), (the process 2 and the process 4)}
Pair 3: {(the process 1 and the process 4), (the process 2 and the process 3)}

Among the three combinations, when the process 1 and the process 2 are simultaneously performed in the pair 1, a data server 2 (402) must transmit replicated file data to a data server (403) at the same time while receiving the replicated file data from a data server 1 (401). Then, when the process 3 and the process 4 are simultaneously performed, a data server 4 (404) must simultaneously transmit the replicated file data to the data servers 1 and 3 (401 and 403).

In addition, when the process 1 and the process 4 are simultaneously performed in the pair 3, the data server 1 (401) must receive the replicated file data from the data server 4 (404) at the same time while transmitting the replicated file data to the data server 2 (402). Then, when the process 2 and the process 3 are simultaneously performed, the data server 3 (403) must simultaneously receive the replicated file data from the data servers 2 and 4 (402 and 404).

Therefore, when the data block replication processes are paired like in the pair 1 or 3, efficiency of parallel replication processes is not high and it takes longer to perform the parallel replication processes.

On the other hand, when the process 1 and the process 3 are simultaneously performed like in the pair 2, all of the four data servers 401 to 404 perform only one of an operation of receiving the replicated file data and an operation of transmitting the replicated file data. In addition, when the process 2 and the process 4 are simultaneously performed, all of the four data servers 401 to 404 perform only one of an operation of receiving the replicated file data and an operation of transmitting the replicated file data. Therefore, efficiency of parallel replication processes is high and it takes a long time to perform the parallel replication processes.

That is, according to the exemplary embodiment of the present invention, a data server that replicates data does not receive a further replication request and the replication processing apparatus transmits the replication request only to a data server that does not replicate data so that it is possible to reduce time spent on replicating a data block.

In order for one data server to replicate a data block in parallel, intradata re-replication parallelism p and inter data re-replication parallelism P must be considered. Equation 2 represents the intradata re-replication parallelism p and Equation 3 represents the inter data re-replication parallelism P.

$$\begin{matrix}p = \frac{T ( {B ( a , b )}_{id , offset , len} ) )}{Min ( \begin{matrix}{Wait}_{a} ( {T}_{b} ( {Recv}_{len} + {Write}_{p 2 , len} ) ) , \\ {Wait}_{b} ( {T}_{a} ( {Read}_{p 1 , len} + {Send}_{p 1 , len} ) )\end{matrix} )} \\ \begin{matrix}T ( {B ( a , b )}_{id , offset , len} ) ) = {T}_{a} ( {Read}_{p 1 , len} + {Send}_{len} ) + \\ {T}_{b} ( {Recv}_{len} + {Write}_{p 2 , len} ) \\ = {T}_{a} ( {Read}_{p 1 , len} + {Send}_{len} ) + \\ {Wait}_{a} ( {T}_{b} ( {Recv}_{len} + {Write}_{p 2 , len} ) ) \\ \approx {Wait}_{b} ( {T}_{a} ( {Read}_{p 1 , len} + {Send}_{p 1 , len} ) ) + \\ {T}_{b} ( {Recv}_{len} + {Write}_{p 2 , len} )\end{matrix} & ( Equation 2 ) \\ P = \frac{n ( \{ DS \vert DS ( Data Server ) is not Failed \} )}{2} & ( Equation 3 )\end{matrix}$$

Referring to the Equations 2 and 3, the maximum number of data servers that may be simultaneously requested by the replication processing apparatus to perform replication processes at time t may be represented by Equation 4.

Max(Data Block Requests)ₜ=p*P (Equation 4)

When a data server is out of order, the replication processing apparatus finds a replicated data block of a data block included in the data server that is out of order from another data server and re-replicates the found data block. At this time, the maximum number of replication processes that the replication processing apparatus may simultaneously perform in parallel is p×P.

On the other hand, when a data block to be replicated is concentrated on a specific data server, the parallel data replication processes may not be effectively performed. Therefore, when file data is divided in units of data blocks to be stored in data servers, respectively, it is necessary to uniformly disperse the respective data blocks into all the data servers included in a network.

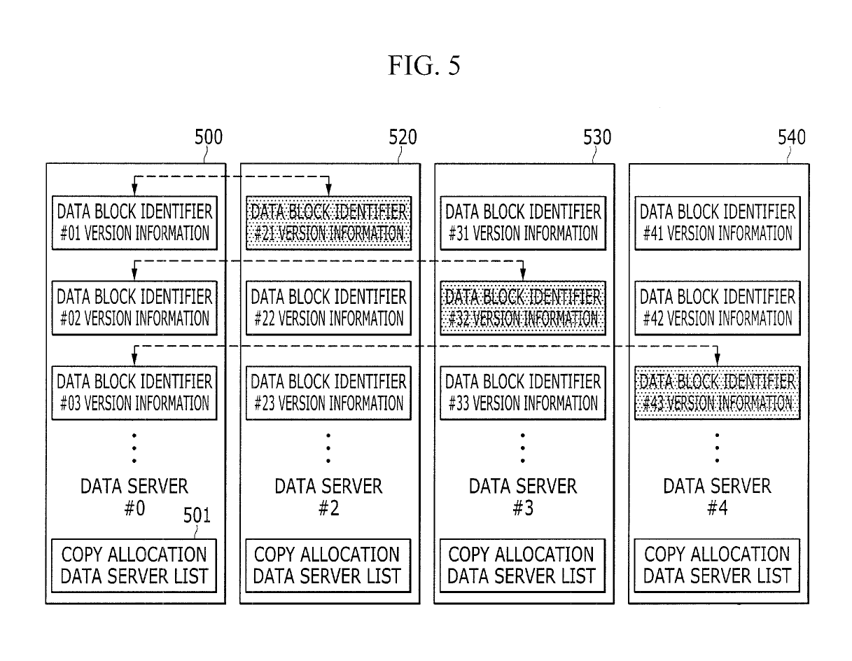

FIG. 5 is a view illustrating a plurality of data blocks replicated in data servers according to an exemplary embodiment of the present invention.

Referring to FIG. 5, a data block stored in a data server 0 (500) may be copied to remaining data servers 520 to 540 excluding the data server 0 (500).

In order to disperse a copy data block into a plurality of data servers to be stored in the plurality of data servers, a data server that stores an original data block maintains a list (hereinafter, referred to as “a copy allocation data server list”) 501 of data servers in which the copy data block is stored.

That is, the data server that stores the original data block may transmit the copy data block to another data server and may list an address of the other data server. The data server that stores the original data block may search the copy allocation data server list and may store the copy data block in a data server that is not in the copy allocation data server list.

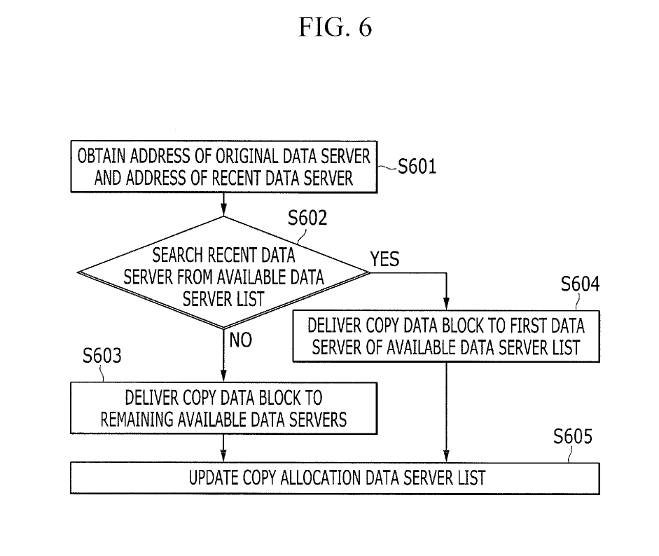

FIG. 6 is a flowchart illustrating processes of allocating a copy data block according to an exemplary embodiment of the present invention.

First, when a replication request event of a data block is generated, the replication processing apparatus finds an address of an original data server in which an original data block is stored and finds an address of a recent data server to which a copy data block is delivered from the original data server (S601). Then, an available data server list to which the copy data block may be delivered is searched so that it is determined whether the recent data server is included in the available data server list (S602).

When it is determined that the recent data server is included in the available data server list, the copy data block is delivered to remaining available data servers obtained by excluding the recent data server from the available data server list (S603). However, when it is determined that the recent data server is not included in the available data server list, the copy data block is delivered to a data server positioned first in the available data server list (S604).

Then, the copy allocation data server list of the original data server is updated (S605).

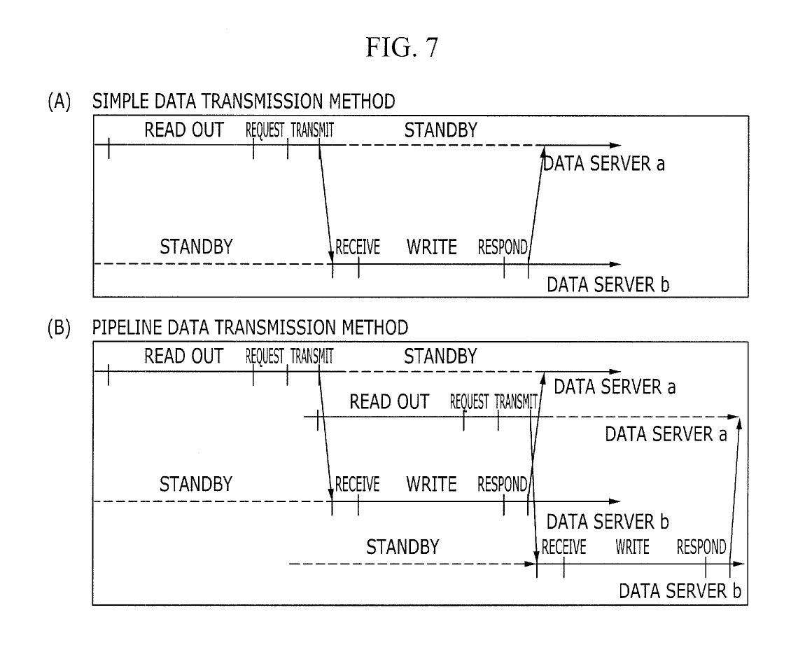

FIG. 7 is a flowchart illustrating processes of replicating a data block in parallel according to an exemplary embodiment of the present invention.

FIG. 7 (A) illustrates a method of replicating a data block from a data server to another data server. Referring to FIG. 7 (A), a data server a reads a part of a data block to transmit the part of the data block to a data server b, and the data server b receives and writes the part of the data block and responds to the data server a that replication of the data block is completed.

Next, the data server a reads and transmits a next part of the data block and transmits the next part of the data block, and the data server b receives and writes the next part of the data block. Such a method is referred to as “a simple data transmission method”, and the data server a that transmits the data block waits for the response of the data server b for a uniform time.

The time required in accordance with the simple data transmission method may be represented by Equation 5.

$$T ( {Repl}_{a \to b} ) = {\sum }_{i = 1}^{N} T ( {B ( a , b )}_{id , offset , len} ) \qquad ( Equation 5 )$$

FIG. 7 (B) illustrates another method of replicating a data block from a data server to another data server. Referring to FIG. 7 (B), the data server a reads a part of a data block to transmit the part of the data block to the data server b. Then, unlike in the simple data transmission method, the data server a reads a next part of the data block without waiting for a response of the data server b, and transmits the next part of the data block to the data server b. That is, in FIG. 7 (B), the data block may be replicated in parallel, which is referred to as “a pipeline data transmission method”.

The time required in accordance with the pipeline data transmission method is represented by Equation 6.

$$T ( {Repl}_{a \to b} ) = \frac{{\sum }_{i = 1}^{N} T ( {B ( a , b )}_{id , offset , len} )}{2} + T ( {B ( a , b )}_{id , ( N - 1 ) * len , len} ) \qquad ( Equation 6 )$$

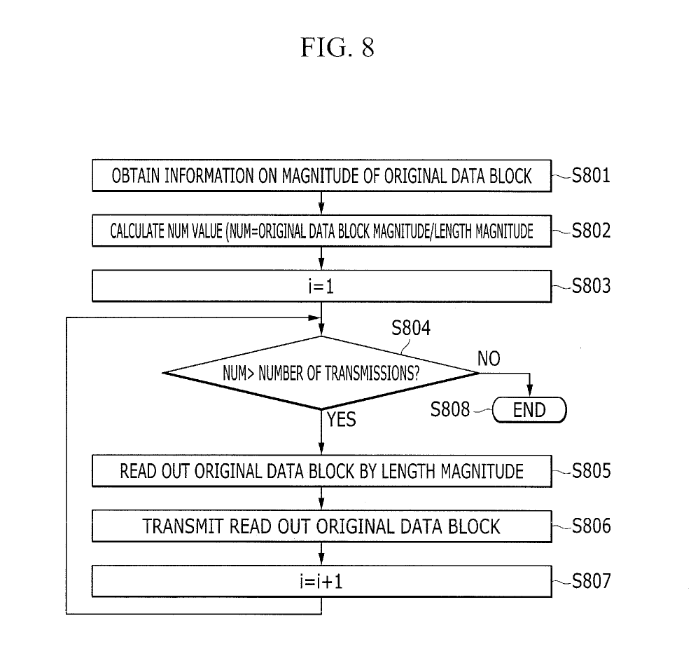

FIG. 8 is a view illustrating processes of a data server transmitting a data block by a pipeline data transmission method according to an exemplary embodiment of the present invention.

Referring to FIG. 8, first, the data server a obtains information on a magnitude of an original data block (S801), calculates a num value using a magnitude by which the original data block is requested to be replicated (S802), and counts a number of transmissions (i) (S803).

When the num value is larger than the number of transmissions (S804), the data server a reads out the original data block from a disk by a length magnitude (S805), and transmits a part of the read out data block to the data server b (S806). The above processes are repeated until the number of transmissions is larger than the num value (S807), and are terminated when the number of transmissions is larger than the num value. Therefore, the data server a may continuously replicate the data block without waiting for the response of the data server b.

According to another exemplary embodiment of the present invention, the magnitude of the original data block is divided by the length magnitude so that the number of times that the original data block is to be transmitted to the data server b is previously calculated.

A ceiling function value of a number obtained by dividing the magnitude of the original data block by the length magnitude may be the number of

$$transmissions ( number of transmissions = ⌈ \frac{original data block magnitude}{length magnitude} ⌉ ) .$$

Then, the data server a may read out the original data block from the disk by the length magnitude and may transmit the read out data block to the data server b by the number of transmissions.

On the other hand, the data server b receives the original data block by the length magnitude and records the received data block in the disk of the data server b.

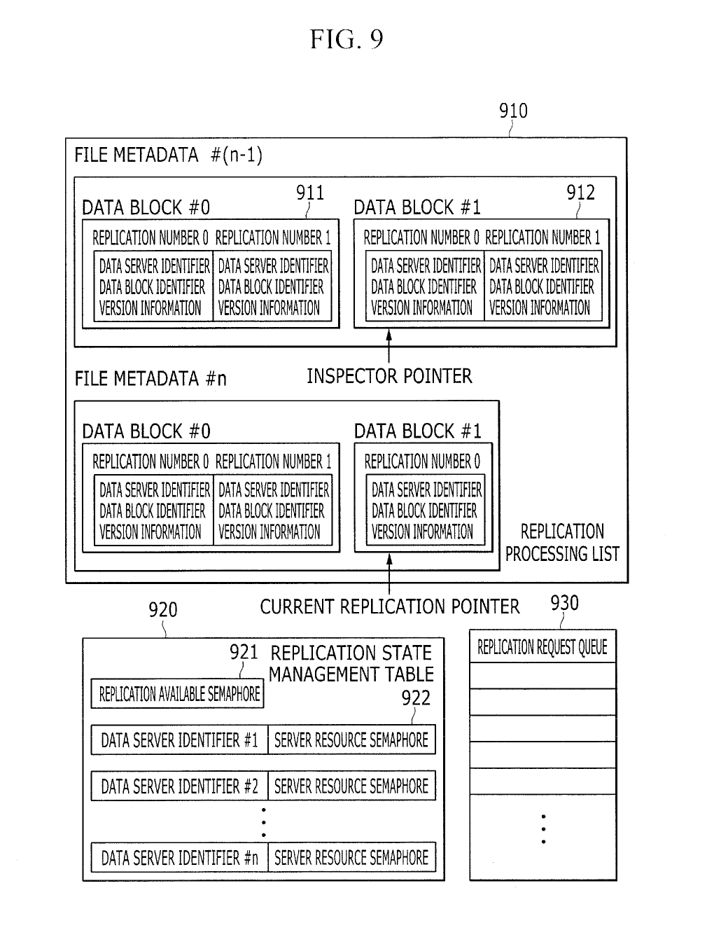

FIG. 9 illustrates a data structure of a replication processing apparatus according to an exemplary embodiment of the present invention.

A replication processing apparatus according to the exemplary embodiment of the present invention manages a replication processing list 910, a replication state management table 920, and a replication request queue 930.

The replication processing list 910 includes file metadata on a data block included in a data server that is out of order in the form of a list.

The replication state management table 920 includes replication available semaphores (the inter data re-replication parallelism P×the intradata re-replication parallelism p) 921 and server resource semaphores 922.

The number of replication available semaphores 921 may be set so that a data block may be replicated in parallel. When replication is requested of more than the predetermined number of replication available semaphores 921, the replication processing apparatus is on standby. That is, according to the exemplary embodiment of the present invention, the replication processing apparatus does not transmit a replication request to a data server that replicates data, but transmits the replication request only to a data server that does not replicate data using the replication available semaphores so that replication time of a data block may be reduced.

The number of server resource semaphores 922 is set so that one data server may replicate a data block. When replication is requested of more than the number of server resource semaphores 922 as with the replication available semaphores 921, the replication processing apparatus is on standby.

The replication request queue 930 stores and manages replication request information when the replication processing apparatus requests a data server to replicate a data block. That is, when the replication request is completed, the replication request queue 930 may bring replication request information using a replication request identifier, and may store the replication request information. At this time, the replication request identifier may be included in a response message transmitted by a data server in which a copy data block is stored. In addition, the replication request queue 930 may determine whether time-out of the replication request is generated using request time of the replication request information.

The replication processing list 910 may search file metadata corresponding to a data block to be replicated, may obtain the replication available semaphores 921 from the replication state management table 920, and may obtain the server resource semaphores 922 of the respective data servers to replicate the data block.

Referring to FIG. 9, a current replication pointer represents a current position of inspected file metadata in the replication processing list, and an inspector pointer represents a first data block pointer that may not be currently replicated.

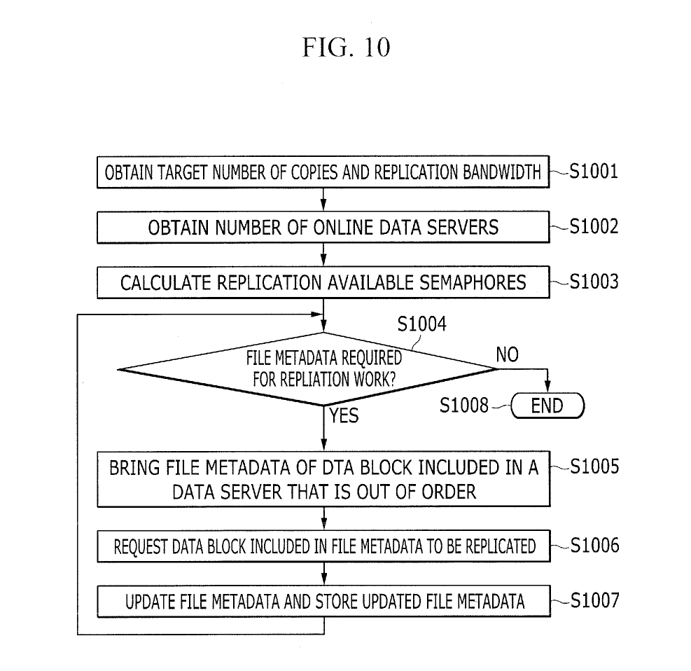

FIG. 10 is a view illustrating processes of a replication processing apparatus replicating a data block according to an exemplary embodiment of the present invention.

The replication processing apparatus obtains the target number of copies and a replication bandwidth (S1001). Then, the replication processing apparatus finds the number of online data servers through the data server management table (S1002) and calculates replication available semaphore values based on the number of online data servers and the inter data re-replication parallelism P (S1003). At this time, the replication available semaphore values may be calculated by Equation 7.

$$replication available sempahores = \frac{online data servers}{2} \times P \qquad ( Equation 7 )$$

Then, the replication processing apparatus searches whether there are file metadata required to be replicated in a metadata list (S1004). When there is file metadata required to be replicated, file metadata of a data block included in a data server that is out of order is brought from a metadata server (S1005). Then, a data block included in the file metadata in a replication processing list is requested to be replicated (S1006).

When a copy data block of the data block included in a data server that is out of order is replicated, the file metadata of the data block included in a data server that is out of order is updated and the updated file metadata is stored in the metadata server (S1007).

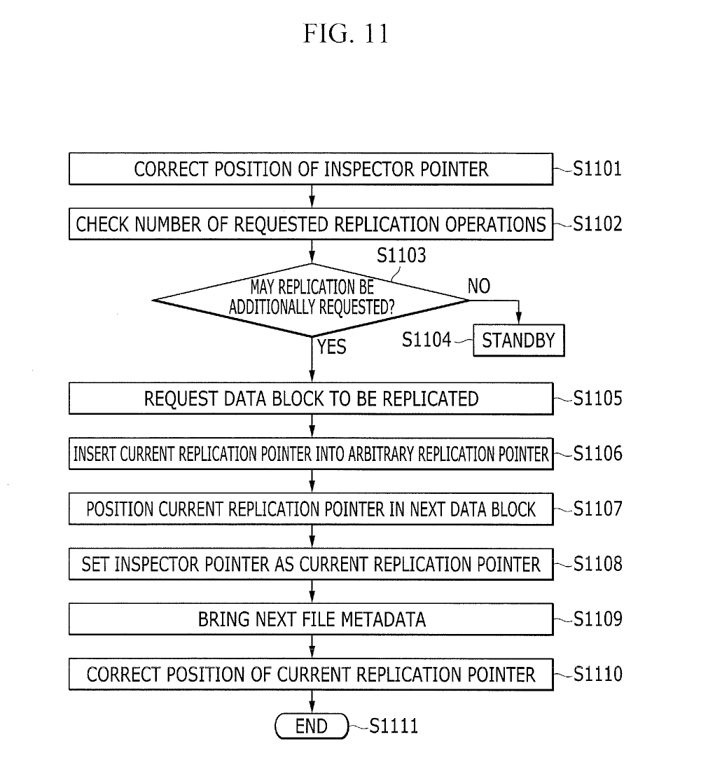

FIG. 11 is a flowchart illustrating processes of re-replicating a data block in parallel according to an exemplary embodiment of the present invention.

Referring to FIG. 11, first, when the target number of copies of file data is set or a replication request for the file data is generated, the replication processing apparatus positions an inspector pointer to a first data block of first file metadata included in a replication processing list (S1101). Next, it is determined whether the replication processing list is empty so that it is determined whether there are requested replication operations (S1102).

When it is determined that the replication processing list is not empty and there are requested replication operations, the replication processing apparatus determines whether the number of replication requests in the replication request queue is smaller than the replication available semaphores (p×P) and determines whether replication may be further requested (S1103).

That is, when the number of replication requests is larger than or equal to the replication available semaphores, since replication may not be further requested, the replication processing apparatus is on standby (S1104). Then, when the replication processing apparatus is on standby, the inspector pointer is left for replication to be performed later.

When the number of replication requests is smaller than the replication available semaphores, since replication may be performed, a data block of a current replication pointer is brought to determine whether replication is required, and when it is determined that it is required to replicate the data block, the data block is requested to be replicated (S1105). That is, the number of copies of a data block is compared with the target number of copies so that, when the number of copies of the data block is smaller than the target number of copies, the corresponding data block is requested to be replicated.

When replication of the data block is completed, the block position of the current replication pointer and the number of data blocks included in file metadata in which the current replication pointer is positioned are brought. Then, in order to store the current replication pointer, the current replication pointer is put into an arbitrary replication pointer (S1106).

Then, when a data block in which the current replication pointer is positioned is not a last data block among the data blocks included in the file metadata, the current replication pointer is positioned in a next data block (S1107). Then, when replication of the data block requested to be replicated is completed, the inspector pointer is set as the current replication pointer (S1108).

On the other hand, when the data block in which the current replication pointer is positioned is the last data block among the data blocks included in the file metadata, next file metadata is brought from the replication processing list (S1109). Then, the replication processing apparatus positions the current replication pointer in the first data block of the brought file metadata (S1110).

At this time, when there is no file metadata to be brought, the replication processing list is scanned again, and when there is no replication operation to be processed in the replication processing list, processes are terminated (S1111).

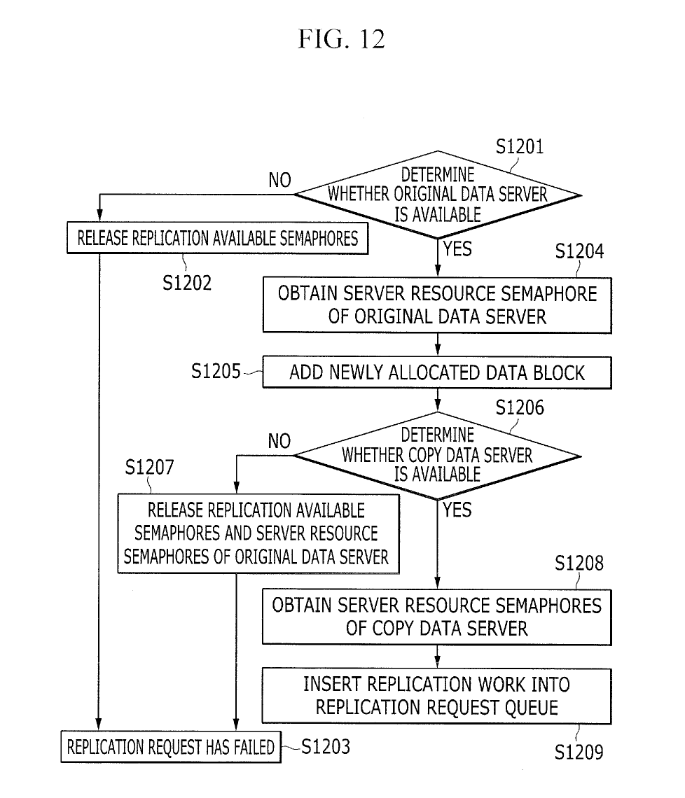

FIG. 12 is a flowchart illustrating processes of a replication processing apparatus determining a data server to perform replication according to an exemplary embodiment of the present invention.

The exemplary embodiment of the present invention described in FIG. 12 may be a detailed description of S1105 of FIG. 11.

Referring to FIG. 12, the replication processing apparatus determines whether replication may be performed through server resource semaphores of a data server (an original data server) that stores a data block required to be replicated (S1201). That is, only when there are server resource semaphores of the original data server may the replication processing apparatus request the original data server to perform replication.

When there are no server resource semaphores of the original data server, since replication may not be performed, the replication available semaphores are released (S1202) and a replication request is not completed (S1203).

On the other hand, when there are server resource semaphores of the original data server, one server resource semaphore of the original data server is obtained (S1204).

Then, the data block in which the current replication pointer is positioned is brought from the file metadata, and a newly allocated data block is added to the file metadata (S1205). A version number of the added data block is set as 0.

Then, it is determined whether a copy data server in which a copy data block is to be stored is available through server resource semaphores of the copy data server (S1206). When the copy data server is not available, the previously obtained replication available semaphores and the server resource semaphores of the original data server are released (S1207), and the replication processing apparatus is informed that replication has failed (S1203).

On the other hand, when the copy data server in which the copy data block is to be stored is available, the server resource semaphores of the copy data server are obtained (S1208), and replication operations are inserted into the replication request queue (S1209).

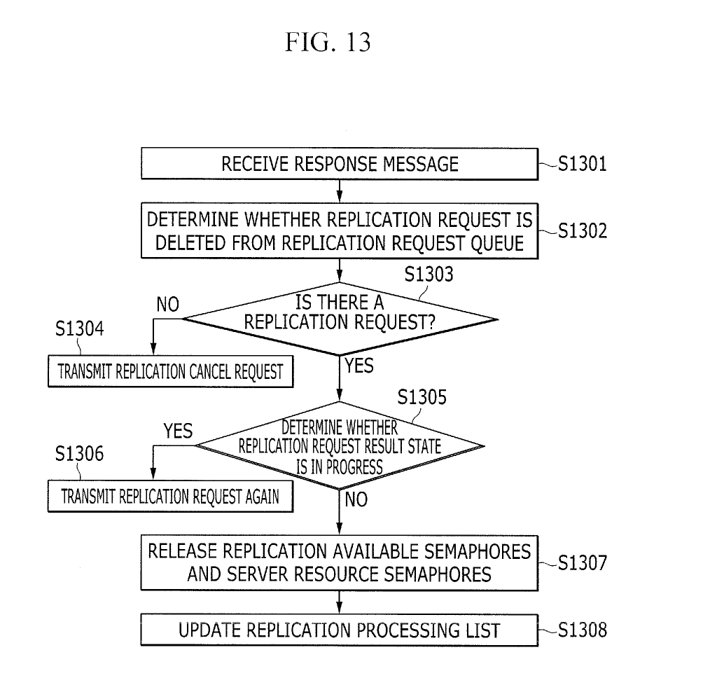

FIG. 13 is a flowchart illustrating processes of a replication processing apparatus processing a response message received from a data server according to an exemplary embodiment of the present invention.

According to the exemplary embodiment of the present invention, when a data block is transmitted from an original data server to a copy data server and is recorded in the copy data server, the copy data server informs the original data server that replication is completed and the original data server transmits a response message on a replication request to the replication processing apparatus. That is, the response message may inform the replication processing apparatus that the replication request is accepted and the data block is successfully replicated.

Referring to FIG. 13, first, the replication processing apparatus receives the response message transmitted by the data server through a network (S1301). Then, the replication processing apparatus recognizes a replication request identifier included in the response message to determine whether the corresponding replication request is to be deleted from the replication request queue (S1302). When the corresponding replication request is not in the replication request queue (S1303), a replication cancel request is transmitted to the data server that transmits the response message (S1304).

However, when the corresponding replication request is in the replication request queue, it is determined whether a result state of the replication request included in the response message is in progress (S1305). When it is determined that the result state is in progress, the corresponding replication request is not deleted and the replication request is transmitted to the data server again (S1306).

However, when the result state is not in progress, the replication processing apparatus releases the obtained replication available semaphores and the server resource semaphores of the data server one by one (S1307). Finally, the replication processing apparatus updates the replication processing list (S1308).

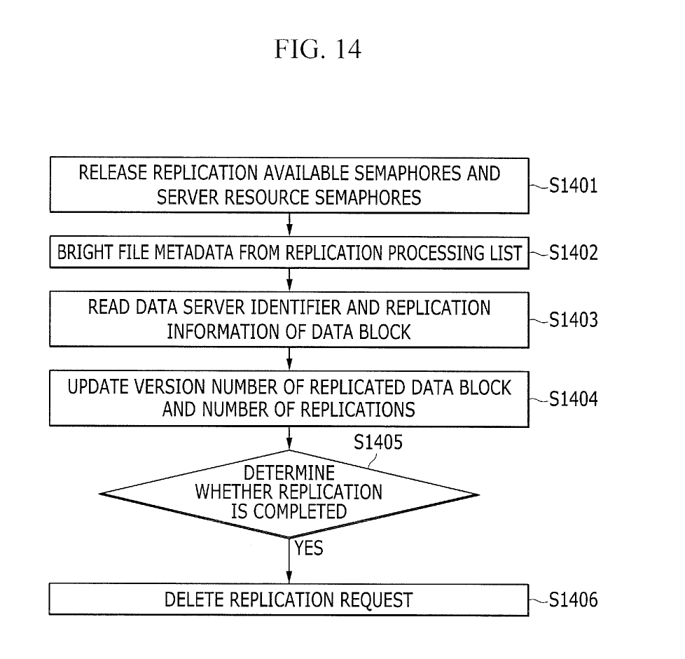

FIG. 14 is a flowchart illustrating processes of a replication processing apparatus updating a replication processing list according to an exemplary embodiment of the present invention.

The exemplary embodiment of the present invention described in FIG. 14 may describe S1308 of FIG. 13. Referring to FIG. 14, when the replication processing apparatus receives the response message and releases the replication available semaphores and the server resource semaphores (S1401), the replication processing apparatus brings the file metadata of the corresponding data block from the replication processing list (S1402). Then, the replication processing apparatus reads out the data server identifier and replication information of the data block from the file metadata of the corresponding data block (S1403). The replication processing apparatus then updates the version number of the replicated data block and the number of replications (S1404).

Then, the replication processing apparatus inspects the data block of the corresponding file metadata to determine whether replication of the data block is completed (S1405). When the number of copies of all the data blocks is equal to the target number of copies, it is determined that all the data blocks included in the file metadata are replicated and the replication request for the corresponding data block is deleted from the replication processing list (S1406).

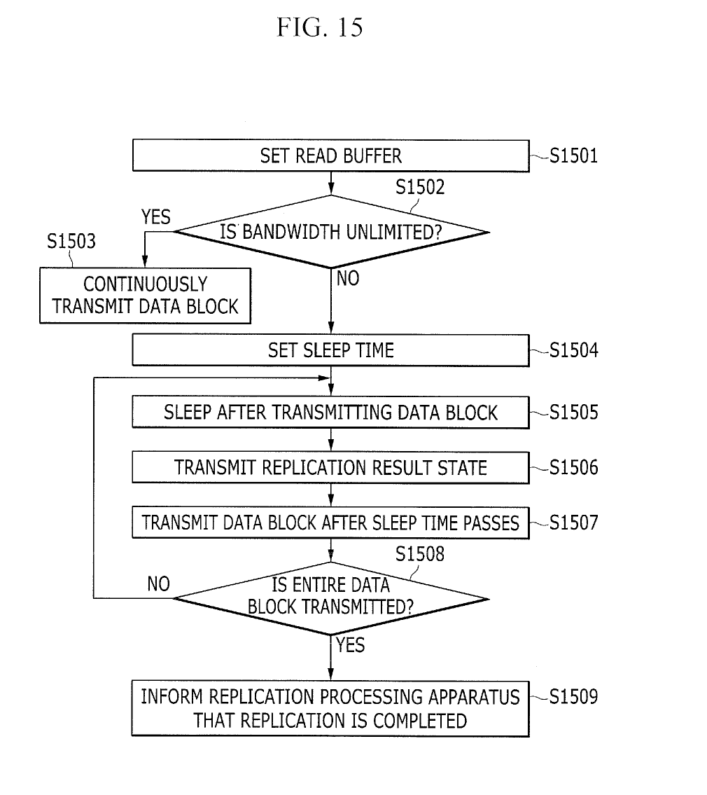

FIG. 15 is a flowchart illustrating processes of an original data server processing a replication request according to an exemplary embodiment of the present invention.

Referring to FIG. 15, the data server (the original data server) that receives the replication request from the replication processing apparatus sets a read buffer of a predetermined magnitude (S1501). Then, the data block corresponding to the data block identifier included in the replication request is read out by the magnitude of the set read buffer (S1502).

When a magnitude of the replication bandwidth recorded in the replication request is unlimited, the original data server continuously transmits the read out data block to the data server (the copy data server) in which the copy data block is to be stored without sleep time (S1503). When the original data server operates in the simple data transmission method, a part of the read out data block is transmitted and a response of the copy data server is waited for. However, when the original data server operates in the pipeline data transmission method, the part of the read out data block may be continuously transmitted without waiting for the response of the copy data server.

On the other hand, when the replication bandwidth recorded in the replication request is limited, the original data server sets sleep time (S1504) and sequentially operates transmission time and sleep time of the read out data block and transmits the data block (S1505). The sleep time may be set as illustrated in Equation 8.

$$\frac{128 KB \times N}{set replication bandwidth} - \frac{128 KB \times N}{server maximum bandwidth} \\ ( N = the number of actually performed replications without sleep , unit = 128 KB ) \qquad ( Equation 8$$

Then, at the sleep time, transmission of a part of the read out data block is stopped, the response of the copy data server is waited for, and the replication result state is transmitted to the replication processing apparatus (S1506). At this time, the original data server transmits the replication result state to be in progress (an in progress message) and the replication processing apparatus may shift time-out for the corresponding replication request through the in progress message.

That is, in the replication processing apparatus according to the exemplary embodiment of the present invention, the time-out may be set so that the replication work may be deleted when the time set as the time-out passes. The respective data servers may prevent the replication processing apparatus from arbitrarily terminating the time-out using the in progress message in spite of the sleep time.

Then, when the sleep time passes, the original data block continuously transmits the part of the read out data block (S1507). Then, when the original data server transmits the entire read out data block (S1508), the replication processing apparatus is informed that replication is completed (S1509).

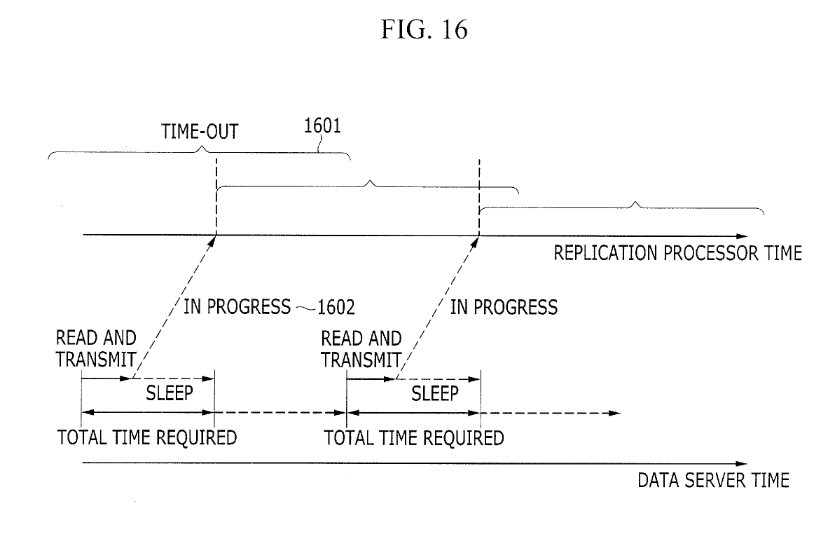

FIG. 16 is a view illustrating processes of controlling a replication bandwidth according to an exemplary embodiment of the present invention.

First, the replication processing apparatus sets time-out 1601 to request a data server to replicate a data block. The data server receives the replication request and starts to replicate the data block such that the entire data block may not be replicated at one time but a part of the data block may be replicated with sleep time, and then a next part of the data block may be replicated with sleep time.

At this time, the data server replicates a part of the data block and transmits an in progress message 1602 to the replication processing apparatus. The data server transmits the in progress message to the replication processing apparatus every time after replication of a part of the data block is completed until the entire data block is replicated.

The replication processing apparatus that receives the in progress message from the data server then starts the set time-out again. That is, the time-out is not terminated while the in progress message is received.

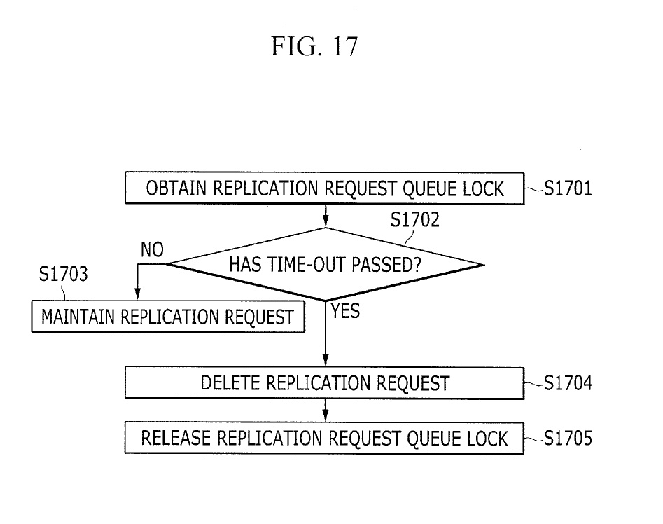

FIG. 17 is a flowchart illustrating processes of a replication processing apparatus applying time-out according to an exemplary embodiment of the present invention.

Referring to FIG. 17, first, the replication processing apparatus obtains a replication request queue lock (S1701). That is, the replication processing apparatus obtains a lock for the replication request queue so that the replication request may be deleted from the replication request queue and information on the replication request may be searched from the replication request queue.

Then, the replication request queue searches the information on the replication request so that, when it is determined that the time-out has not passed (S1702), the replication request is maintained (S1703). However, when it is determined that the time-out has passed, the current replication pointer is set as a next replication request and the corresponding replication request is deleted from the replication request queue (S1704).

When there is no current replication pointer so that all the replication requests included in the replication request queue are inspected, the replication processing apparatus releases the replication request queue lock (S1705).

As described above, according to the exemplary embodiment of the present invention, a method of efficiently replicating data stored in a plurality of data servers in an asymmetric file system is provided. A replication processing apparatus of a network transmits a replication request only to a data server that does not perform a data replication operation so that it is possible to reduce replication time of a data block and to extend time-out with reference to a response message transmitted by the data server. In addition, each of the data servers may efficiently transmit copy data to another data server by the pipeline data transmission method.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of a replication processing apparatus replicating a data block stored in a plurality of data servers, the method comprising:
determining whether at least two data servers among the plurality of data servers may replicate the data block;
when it is determined that the at least two data servers may replicate the data block, selecting a first data server in which the data block is stored and a second data server in which the data block is not stored from the at least two data servers;
transmitting a replication request of the data block to the first data server; and
receiving a response message from the first data server.

2. The method of claim 1, wherein the determining of whether at least two data servers among the plurality of data servers may replicate the data block comprises:
comparing the number of replication requests that are on standby in a replication request queue of the replication processing apparatus with a number of replication available semaphores; and
determining that the data block may be replicated when the number of replication requests is smaller than the number of replication available semaphores.

3. The method of claim 2, wherein the number of replication available semaphores is calculated using an intradata re-replication parallelism value and an inter data re-replication parallelism value.

4. The method of claim 3, wherein the intradata re-replication parallelism value is obtained by dividing the number of online data servers by 2.

5. The method of claim 1, further comprising searching file metadata including position information of the data block to determine whether the data block is to be replicated.

6. The method of claim 5, wherein, in searching file metadata including position information of the data block to determine whether the data block is to be replicated, the data block is determined to be replicated when the number of data blocks included in the file metadata is smaller than the target number of copies set by the replication processing apparatus.

7. The method of claim 1, wherein selecting a first data server in which the data block is stored and a second data server in which the data block is not stored from the at least two data servers comprises:
determining whether the first data server and the second data server may replicate the data block through server resource semaphores of the first data server and the second data server; and
selecting the first data server and the second data server when the server resource semaphores exist in the first data server and the second data server.

8. The method of claim 1, wherein transmitting a replication request of the data block to the first data server comprises transmitting a request identifier of the replication request and an identifier of the data block to the first data server.

9. The method of claim 1, wherein receiving a response message from the first data server comprises receiving a response message informing that a replication request is successfully fulfilled when the data block stored in the first data server is successfully replicated in the second data server.

10. The method of claim 2, further comprising starting time-out for the replication request after transmitting the replication request,
wherein receiving the response message comprises determining whether the time-out is to be terminated based on the response message.

11. The method of claim 10, wherein determining whether the time-out is to be terminated comprises starting the time-out again when an in progress message is included in the response message and the response message is received before the time-out for the replication request is terminated.

12. The method of claim 10, wherein determining whether the time-out is to be terminated comprises recognizing an identifier of the replication request included in the response message to delete the replication request from the replication request queue when an in progress message is not included in the response message or the response message is received after the time-out for the replication request is terminated.

13. A method of a data server that stores a data block to replicate the data block, the method comprising:
receiving a first replication request of the data block from a replication processing apparatus through a network;
reading out a first part of the data block by a predetermined buffer magnitude;
transmitting a read out part of the first part to the first data server in which the data block is not stored;
transmitting an in progress message for the replication request to the replication processing apparatus; and
receiving a second replication request of the data block from the replication processing apparatus as a response to the in progress message.

14. The method of claim 13, further comprising, after transmitting a read out part of the first part:
reading out a second part of the data block by a predetermined buffer magnitude;
transmitting a read out part of the second part to the first data server; and
transmitting the in progress message to the replication processing apparatus.

15. The method of claim 13, further comprising, after transmitting the in progress message:
sleeping for predetermined sleep time;
reading out a remaining part of the first part by the buffer magnitude after the sleep time passes; and
transmitting a read out part of the remaining part to the first data server.

16. The method of claim 14, further comprising, after transmitting the in progress message:
sleeping for predetermined sleep time;
reading out a remaining part of the second part by the buffer magnitude after the sleep time passes; and
transmitting a read out part of the remaining part to the first data server.

17. The method of claim 15, wherein the sleep time is determined using a replication bandwidth allocated by the replication processing apparatus, a maximum bandwidth of the data server, and the buffer magnitude.

18. The method of claim 16, wherein the sleep time is determined using a replication bandwidth allocated by the replication processing apparatus, a maximum bandwidth of the data server, and the buffer magnitude.
